(19) United States
(12) Patent Application Publication
(10) Pub. No.: US 2011/0115707 A1
(43) Pub. Date: May 19, 2011

(54) METHOD AND DEVICE FOR SWITCHING CHARACTER INPUT MODE

(75) Inventors: Yan-Rui Zhang, Guangzhou (CN); Heng-Ling Mei, Guangzhou (CN); Zhi-Jian Yan, Guangzhou (CN); Yun-Ting Kong, Guangzhou (CN)

(73) Assignee: PRIMAX ELECTRONICS LTD., Taipei (TW)

(21) Appl. No.: 12/699,401

(22) Filed: Feb. 3, 2010

(30) Foreign Application Priority Data
Nov. 13, 2009 (TW) 098138665

(51) Int. Cl. G06F 3/033; G06F 3/02

(52) U.S. Cl. 345/163; 345/168

(57) ABSTRACT

A method and a device are used for switching a character input mode of a computer system. The character input mode switching device includes an input device, a display unit and an operating system unit. The input device includes a switching control element and a main control unit. The main control unit includes a switching module. An input signal is generated by the switching control element according to a single-step operation of a user and transmitted to the switching module. A switching signal is generated by the switching module after the input signal is received. The operating system unit judges whether the switching signal is an input language switching signal or an input method switching signal after the switching signal is received. According to the switching signal, the input language or the input method is switched by the operating system unit.

### FIELD OF THE INVENTION

The present invention relates to a character input mode switching method and a character input mode switching device for use in a computer system, and more particularly to a character input mode switching method and a character input mode switching device for switching a character input mode by pressing a single key, clicking a button, rotating a scroll wheel or voice control.

### BACKGROUND OF THE INVENTION

With increasing development of high technology industries, computers become essential electronic apparatuses in our daily lives. For example, computers can be employed for working purposes or chatting through Internet connection. As known, it is important to input character in order to operate the computer. During the process of inputting characters into the computer, the character input modes (e.g. input method or input language) are frequently switched according to the practical requirements. Take a widely-used Microsoft Windows operating system for example. By pressing a predetermined composite key (e.g. “ALT+SHIFT” or “CTL+SHIFT”), the input method or input language may be switched. Alternatively, the user may move a mouse to click a language bar in order to switch the input method or input language.

The process of switching the character input mode by pressing the composite key, however, still has some drawbacks. For example, the user needs to well know and search the locations of the composite key and simultaneously press the plural keys of the composite key. Such a character input mode switching method is not user-friendly and readily suffered from erroneous operations. Moreover, since the user is usually confused among several composite keys (e.g. “ALT+SHIFT” and “CTL+SHIFT”), it takes much time to search the desired composite key.

The process of moving a mouse to click the language bar to switch the input method or input language needs a multi-step operation of a user. The multi-step operation needs several steps and is time-consuming. If the input method or input language is frequently switched, the speed of inputting characters is reduced. In addition, if the computer system has a malfunction and the language bar on the lower right corner of the computer screen disappears, the use of the mouse fails to switch the input method or input language. From the above discussions, the convenience and the speed of switching the character input mode by using a composite key or a mouse are still unsatisfactory.

For solving the above drawbacks, Chinese Patent No. CN200620135515.3 disclosed a switching device with a single switching key in order to switch the input method or input language. The switching key is connected to the signal codes of a first function key and a second function key. The combination of the signal codes of the first function key and the second function key is equivalent to one of the composite keys “Alt+Shift”, “Ctrl+Shift”, “Shift+Space” and “Ctrl+Space”. The input method or input language may be switched by pressing the switching key. The switching key is only connected to one of the composite keys. If the composite key has a specified function of switching the input method (or the input language), the action of pressing the switching key only has the specified function. Assuming that the switching key is connected to the signal codes of the composite key “Ctrl+Shift” and the composite key “Ctrl+Shift” is defined as a default input method switching mode by the current operating system, the action of pressing the switching key may switch the input method but fail to switch the input language. If the switching function of the composite key corresponding to the switching key is changed, the original switching function is disabled. Moreover, the switching device is only applied to the keyboard having the first function key and the second function key, but fails to be applied to a mouse or other electronic device. In other words, such a switching device has a narrow scope of application.

### SUMMARY OF THE INVENTION

The present invention relates to a character input mode switching device and a character input mode switching method having a broader scope of application.

In accordance with an aspect of the present invention, there is provided a character input mode switching method for switching a character input mode of a computer system. The computer system includes an input device, an operating system unit and a display unit. The input device includes a switching control element and a main control unit. The operating system unit is electrically connected to the main control unit and the display unit. The main control unit includes a switching module. Firstly, an input signal is generated by the switching control element according to a single-step operation of a user, and transmitted from the switching control element to the switching module. Then, a switching signal predetermined for switching the character input mode is generated by the switching module after the input signal is received by the switching module, and transmitted from the switching module to the operating system unit. After the switching signal is received by the operating system unit, the operating system unit judges whether the switching signal is an input language switching signal or an input method switching signal. If the switching signal is the input language switching signal, the input language is switched by the operating system unit. Whereas, if the switching signal is the input method switching signal, the input method is switched by the operating system unit.

In an embodiment, the input device is a keyboard, and the switching control element is a switching key. The single-step operation in response to the input method switching signal is performed by shortly pressing the switching key once. In addition, the single-step operation in response to the input language switching signal is performed by continuously pressing the switching key once for a certain time period.

In an embodiment, the input device is a keyboard, and the switching control element is a switching key. The single-step operation in response to the input method switching signal is performed by pressing the switching key once. In addition, the single-step operation in response to the input language switching signal is performed by successively pressing the switching key twice.

In an embodiment, the input device is a mouse, and the switching control element is a mouse button. The single-step operation in response to the input method switching signal is performed by single-clicking the mouse button. In addition, the single-step operation in response to the input language switching signal is performed by double-clicking the mouse button.

In an embodiment, the switching control element is a scroll wheel. The single-step operation in response to the input method switching signal and the single-step operation in response to the input language switching signal are performed by rotating the scroll wheel in different directions.

In an embodiment, the step of switching the input language by the operating system unit includes sub-steps of acquiring a current input language, acquiring an installed input language list of the operating system unit, acquiring a next input language, and selecting the next input language to work.

In an embodiment, the step of switching the input method by the operating system unit includes sub-steps of acquiring a current input language and a current input method, acquiring an input method list under the current input language, acquiring a next input method under the current input language, and selecting the next input method under the current input language to work.

In accordance with another aspect of the present invention, there is provided a character input mode switching device. The character input mode switching device includes an input device, a display unit and an operating system unit. The input device includes a switching control element and a main control unit. The main control unit includes a switching module. An input signal is generated by the switching control element according to a single-step operation of a user and transmitted to the switching module. A switching signal predetermined for switching the character input mode is generated by the switching module after the input signal is received by the switching module. The operating system unit is electrically connected to the main control unit and the display unit for receiving the switching signal from the switching module. The operating system unit judges whether the switching signal is an input language switching signal or an input method switching signal after the switching signal is received by the operating system unit. If the switching signal is the input language switching signal, the input language is switched by the operating system unit. If the switching signal is the input method switching signal, the input method is switched by the operating system unit.

In an embodiment, the input device is a keyboard or a mouse.

In an embodiment, the switching control element is a key of a keyboard, a button of a mouse, a scroll wheel, a slide switch, a touch-sensitive board, a voice operated switch or an accelerometer.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram illustrating a character input mode switching device according to an embodiment of the present invention;

FIG. 2 is a flowchart illustrating a character input mode switching method according to an embodiment of the present invention;

FIG. 3 is a flowchart illustrating a strategy of operating the switching module of the main control chip unit used in the character input mode switching device of the present invention; and

FIG. 4 is a flowchart illustrating a process of executing a switching program in the operating system of the character input mode switching device of the present invention.

### DETAILED DESCRIPTION OF THE PREFERRED EMBODIMENT

The present invention provides a character input mode switching device. The present invention will now be described more specifically with reference to the following drawings and embodiments.

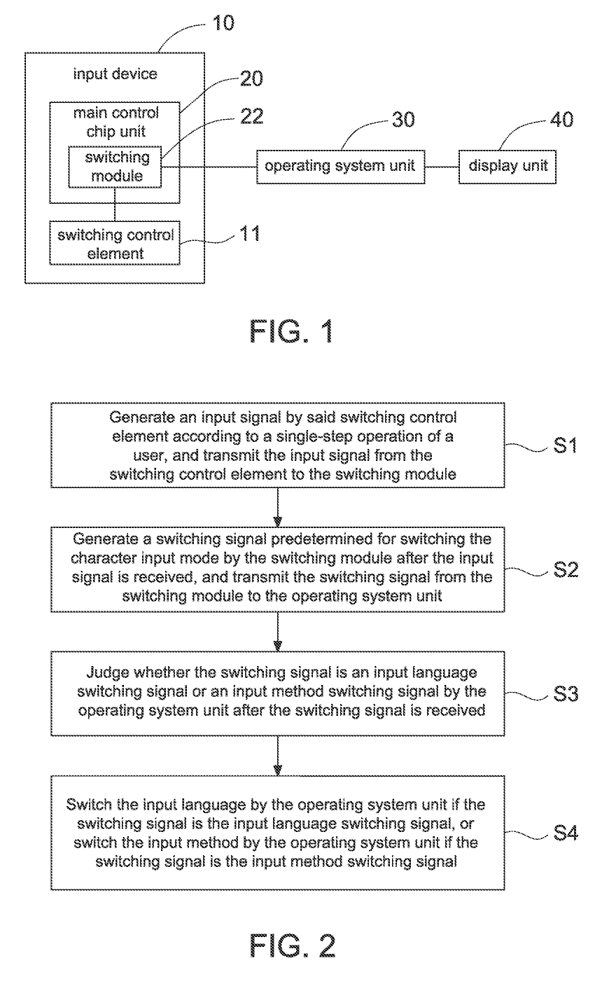

FIG. 1 is a schematic functional block diagram illustrating a character input mode switching device according to an embodiment of the present invention. The switching device comprises an input device 10, an operating system unit 30 and a display unit 40.

In this embodiment, the input device 10 is a keyboard. The input device 10 comprises a switching control element 11 and a main control chip unit (e.g. a keyboard IC) 20. The switching control element 11 is a dependent switching key. The switching control element 11 is electrically connected to the main control chip unit 20. The switching control element 11 is not electrically connected to some specified keys (e.g. “ALT”, “CTRL”, “SHIFT” or “SPACE” key) of the keyboard. In addition, a switching module 22 is included in the main control chip unit 20.

The operating system unit 30 is electrically connected to the main control chip unit 20 of the input device 10 and the display unit 40. An example of the display unit 40 includes but is not limited to a cathode ray tube (CRT) monitor or liquid crystal display (LCD) monitor.

FIG. 2 is a flowchart illustrating a character input mode switching method according to an embodiment of the present invention. First of all, an input signal is generated by the switching control element 11 according to a single-step operation of a user, and the input signal is transmitted to the switching module 22 (Step S1). After the input signal is received by the switching module 22, a switching signal predetermined for switching a character input mode is generated by the switching module 22 and transmitted to the operating system unit 30 (Step S2). After the switching signal is received by the operating system unit 30, the operating system unit 30 judges whether the switching signal is an input language switching signal or an input method switching signal (Step S3). If the switching signal is the input language switching signal, the input language is switched by the operating system unit 30 and the switching result is shown on the display unit 40; whereas, if the switching signal is the input method switching signal, the input method is switched by the operating system unit 30 and the switching result is shown on the display unit 40 (Step S4).

In the above character input mode switching method, the single-step operation in response to the input method switching signal or the input language switching signal is performed by shortly pressing the switching key 11 once or continuously pressing the switching key 11 once for a certain time period.

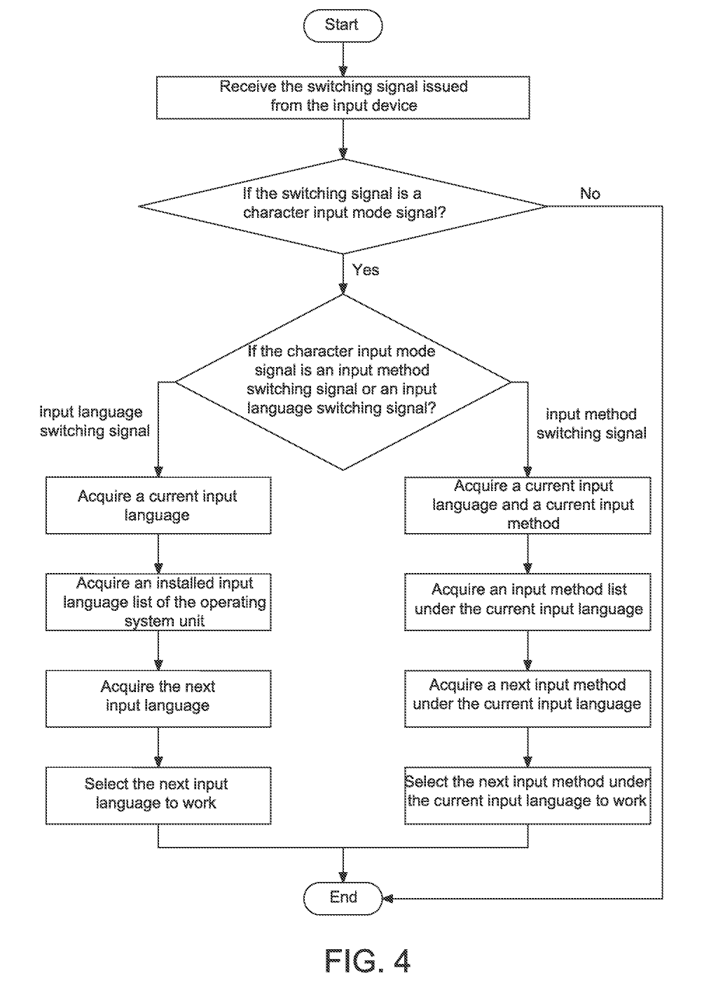

Furthermore, the step of switching the input language by the operating system unit includes sub-steps of acquiring a current input language, acquiring an installed input language list of the operating system unit, acquiring a next input language, and selecting the next input language to work (see FIG. 4).

Furthermore, the step of switching the input method by the operating system unit comprises sub-steps of: acquiring a current input language and a current input method, acquiring an input method list under the current input language, acquiring a next input method under the current input language, and selecting the next input method under the current input language to work (see FIG. 4).

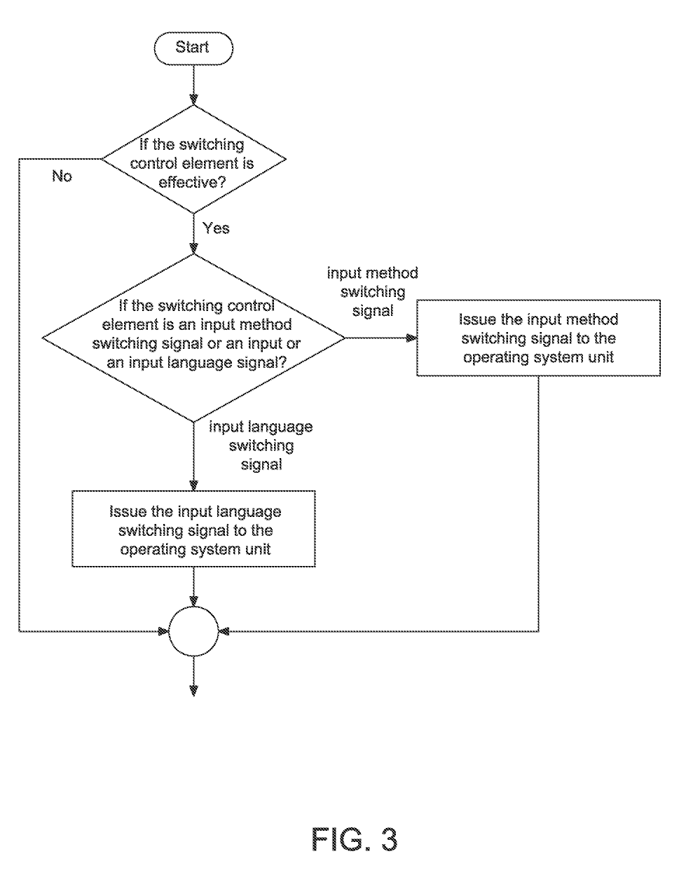

FIG. 3 is a flowchart illustrating a strategy of operating the switching module 22 of the main control chip unit 20 used in the character input mode switching device of the present invention. Firstly, the switching module 22 detects whether the switching control element 11 is effective. An effective switching control element indicates that the switching control element is effectively pressed. Once the input signal is generated by the switching control element 11 according to the single-step operation, the input signal is received by the switching module 22, and a switching signal predetermined for switching a character input mode is generated by the switching module 22 and transmitted to the operating system unit 30 for further judgment. For example, in a case that the single-step operation corresponding to an input method switching mode is performed by pressing the switching key 11 once, an input method switching signal is generated by the switching module 22 according to the received input signal. Assuming that the composite key “Ctrl+Shift” is defined as a default input method switching mode by the current operating system unit 30, the input method switching signal is equivalent to a signal generated by pressing the composite key “Ctrl+Shift”. That is, the action of pressing the switching key 11 once causes the main control chip unit 20 to generate the input method switching signal, which is equivalent to the signal generated by pressing the composite key “Ctrl+Shift”. Then, the input method switching signal is transmitted to the operating system unit 30 for further judgment. Whereas, in a case that the single-step operation corresponding to an input language switching mode is performed by continuously pressing the switching key 11 once or successively pressing the switching key 11 twice, an input language switching signal is generated by the switching module 22 according to the received input signal. Assuming that the composite key “Alt+Shift” is defined as a default input language switching mode by the current operating system unit 30, the input language switching signal is equivalent to a signal generated by pressing the composite key “Alt+Shift”. That is, the action of continuously pressing the switching key 11 once or the action of successively pressing the switching key 11 twice causes the main control chip unit 20 to generate the input language switching signal, which is equivalent to the signal generated by pressing the composite key “Alt+Shift”. Then, the input language switching signal is transmitted to the operating system unit 30.

For changing the default input method switching mode corresponding to the composite key “Ctrl+Shift” and changing the default input language switching mode corresponding to the composite key “Alt+Shift” by the current operating system unit 30, a specified switching program is installed in the operating system unit 30. By executing the switching program, the switching control element 11 is enabled to switch the input method or input language. Hereinafter, a flowchart of executing the switching program will be illustrated with reference to FIG. 4.

Firstly, the switching signal issued from the input device 10 (e.g. a keyboard or a mouse) is received. Then, it is judged whether the switching signal is a character input mode signal. Once the switching signal is the character input mode signal, it is judged whether the character input mode signal is an input method switching signal or an input language switching signal. Once the character input mode signal is the input language switching signal, the following steps are successively performed: acquiring a current input language, acquiring an installed input language list of the operating system unit, acquiring a next input language, and selecting the next input language to work. Whereas, once character input mode signal is the input method switching signal, the following steps are successively performed: acquiring a current input language and a current input method, acquiring an input method list under the current input language, acquiring a next input method under the current input language, and selecting the next input method under the current input language to work.

In some embodiments, the action of pressing the switching key 11 once may cause the switching module 22 to generate an input method switching signal equivalent to the signal generated by pressing the composite key “Alt+Shift”, which is defined as a default input method switching mode by the current operating system unit 30. In addition, the action of continuously pressing the switching key 11 once or the action of successively pressing the switching key 11 twice may cause the main control chip unit 20 to generate an input language switching signal equivalent to the signal generated by pressing the composite key “Ctrl+Shift”, which is defined as a default input language switching mode by the current operating system unit 30.

In some embodiments, the input language is switched by pressing the switching key 11 once, and the input method is switched by continuously pressing the switching key 11 once.

In the above embodiment, the switching control element 11 is a switching key. A modification of the switching control element 11 may be made according to the practical requirements. For example, the switching control element 11 is a scroll wheel (e.g. a regular scroll wheel or a tilt scroll wheel) installed on a mouse or a keyboard. By rotating the scroll wheel in different directions, the input method and the input language are selectively switched. Alternatively, the switching control element 11 is a rotary switch, a slide switch or a voice operated switch. Alternatively, the switching control element 11 is a touch-sensitive board or an accelerometer. For example, the input method is switched by moving the accelerometer leftwards or rightwards, and the input language is switched by moving the accelerometer upwardly or downwardly.

Another example of the input device 10 is a mouse. At the same time, a button (e.g. the left button, the right button or an addition button) of the mouse is served as the switching control element 11. The main control chip unit 20 is the main control chip unit of the mouse. The operating principle of switching the input method or the input language by using the mouse as the input device 10 are identical to those of the keyboard, and are not redundantly described herein. On the other hand, according to the hardware design of the mouse, the input method is switched by single-clicking the switching control element 11, and the input language is switched is by double-clicking the switching control element 11. Alternatively, the input method is switched by double-clicking the switching control element 11, and the input language is switched is by single-clicking the switching control element 11.

In the above embodiments, the purpose of switching the input method (e.g. a Chinese Wubi input method or a Chinese Pinyin input method) or switching the input language (e.g. Chinese or English) will be achieved according to a single-step operation of a user on the switching control element 11 (e.g. the action of pressing the switching control element 11 once or the action of continuously pressing the switching control element 11). Moreover, the character input mode switching device of the present invention may facilitate the user to well and quickly operate the language bar of the Microsoft Windows operating system. Since the first function key and the second function key used in the conventional switched device are omitted in the input device 10 of the present invention, the character input mode switching device of the present invention may be applied to more electronic devices such as keyboard, mouse and the like. Therefore, the character input mode switching device of the present invention has a broader scope of application.

Moreover, the character input mode switching device of the present invention has a plug-and-play capability. Without installing a driver, the purpose of switching the input method or switching the input language will be achieved by operating the switching control element 11. In addition, the original functions of switching the character input mode by pressing corresponding composite keys of the keyboard are not influenced by the character input mode switching device of the present invention. The original functions of switching the input method and the input language by moving and clicking the mouse on the computer monitor are not influenced by the character input mode switching device of the present invention.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A character input mode switching method for switching a character input mode of a computer system, said computer system comprising an input device, an operating system unit and a display unit, said input device comprising a switching control element and a main control unit, said operating system unit being electrically connected to said main control unit and said display unit, said main control unit comprising a switching module, said character input mode switching method comprising steps of:
generating an input signal by said switching control element according to a single-step operation of a user, and transmitting said input signal from said switching control element to said switching module;
generating a switching signal predetermined for switching said character input mode by said switching module after said input signal is received by said switching module, and transmitting said switching signal from said switching module to said operating system unit;
judging whether said switching signal is an input language switching signal or an input method switching signal by said operating system unit after said switching signal is received by said operating system unit; and
switching said input language by said operating system unit if said switching signal is said input language switching signal, or switching said input method by said operating system unit if said switching signal is said input method switching signal.

2. The character input mode switching method according to claim 1 wherein said input device is a keyboard, and said switching control element is a switching key, wherein said single-step operation in response to said input method switching signal is performed by shortly pressing said switching key once, and said single-step operation in response to said input language switching signal is performed by continuously pressing said switching key once for a certain time period.

3. The character input mode switching method according to claim 1 wherein said input device is a keyboard, and said switching control element is a switching key, wherein said single-step operation in response to said input method switching signal is performed by pressing said switching key once, and said single-step operation in response to said input language switching signal is performed by successively pressing said switching key twice.

4. The character input mode switching method according to claim 1 wherein said input device is a mouse, and said switching control element is a mouse button, wherein said single-step operation in response to said input method switching signal is performed by single-clicking said mouse button, and said single-step operation in response to said input language switching signal is performed by double-clicking said mouse button.

5. The character input mode switching method according to claim 1 wherein said switching control element is a scroll wheel, wherein said single-step operation in response to said input method switching signal and said single-step operation in response to said input language switching signal are performed by rotating said scroll wheel in different directions.

6. The character input mode switching method according to claim 1 wherein said step of switching said input language by said operating system unit comprises sub-steps of:
acquiring a current input language;
acquiring an installed input language list of said operating system unit;
acquiring a next input language; and
selecting said next input language to work.

7. The character input mode switching method according to claim 1 wherein said step of switching said input method by said operating system unit comprises sub-steps of:
acquiring a current input language and a current input method;
acquiring an input method list under said current input language;
acquiring a next input method under said current input language; and
selecting said next input method under said current input language to work.

8. A character input mode switching device, comprising:
an input device comprising a switching control element and a main control unit, said main control unit comprising a switching module, wherein an input signal is generated by said switching control element according to a single-step operation of a user and transmitted to said switching module, and a switching signal predetermined for switching said character input mode is generated by said switching module after said input signal is received by said switching module;
a display unit; and
an operating system unit electrically connected to said main control unit and said display unit for receiving said switching signal from said switching module, wherein said operating system unit judges whether said switching signal is an input language switching signal or an input method switching signal after said switching signal is received by said operating system unit, wherein said input language is switched by said operating system unit if said switching signal is said input language switching signal, or said input method is switched by said operating system unit if said switching signal is said input method switching signal.

9. The character input mode switching device according to claim 8 wherein said input device is a keyboard or a mouse.

10. The character input mode switching device according to claim 8 wherein said switching control element is a key of a keyboard, a button of a mouse, a scroll wheel, a slide switch, a touch-sensitive board, a voice operated switch or an accelerometer.
